(19) United States
(12) Patent Application Publication
(10) Pub. No.: US 2012/0133650 A1
(43) Pub. Date: May 31, 2012

(54) METHOD AND APPARATUS FOR PROVIDING DICTIONARY FUNCTION IN PORTABLE TERMINAL

(75) Inventor: Sung Chull LEE, Suwon-si (KR)

(73) Assignee: SAMSUNG ELECTRONICS CO. LTD., Suwon-si (KR)

(21) Appl. No.: 13/306,355

(22) Filed: Nov. 29, 2011

(30) Foreign Application Priority Data
Nov. 29, 2010 (KR) 10-2010-0119303

(51) Int. Cl. G06T 15/00; G06F 3/041

(52) U.S. Cl. 345/419; 345/633

(57) ABSTRACT

A method for detecting a specific object on preview data according to touch based interaction and displaying dictionary result information about the detected object as augmented reality on the preview data, and a portable terminal supporting the same are provided. The method includes displaying preview data of specific contents, receiving touch based interaction on the preview data, detecting an object corresponding to the interaction, searching for additional information about the object, and generating the found additional information as result information and outputting the generated additional information on the preview data based on augmented reality.

### PRIORITY

This application claims the benefit under 35 U.S.C. §119(a) of a Korean patent application filed on Nov. 29, 2010 in the Korean Intellectual Property Office and assigned Serial No. 10-2010-0119303, the entire disclosure of which is hereby incorporated by reference.

### BACKGROUND OF THE INVENTION

1. Field of the Invention

The present invention relates to a method and an apparatus for providing a dictionary function in a portable terminal. More particularly, the present invention relates to a method for providing a dictionary function and result information thereof using real time preview data and augmented reality in a portable terminal having a camera module and a portable terminal supporting the same.

2. Description of the Related Art

In recent years, with the significant development of information, communication and semiconductor technologies, supply and use of all types of portable terminals have rapidly increased. More particularly, recent portable terminals have developed to a mobile convergence stage including traditional unique field and other terminal fields. As a representative example of the portable terminals, a mobile communication terminal provides various functions, such as a TV watching function (e.g., mobile broadcasting, such as Digital Multimedia Broadcasting (DMB) or Digital Video Broadcasting (DVB)), a music playing function (e.g., a Motion Pictures Expert Group (MPEG) Audio Layer-3 (MP3)), a photographing function, and an Internet access function as well as a general communication function, such as voice call or message transmission/reception.

Meanwhile, a dictionary function in a portable terminal of the related art simply provides a dictionary meaning with respect to native language→foreign language (e.g., English) translation for a specific word or a dictionary meaning with respect to foreign language→native language translation for a specific word through an application stored therein. That is, the portable terminal of the related art simply supports a dictionary meaning in the same scheme as using a real dictionary.

In recent years, besides the simple dictionary function, a technology providing a dictionary function by character recognition is applied from photographing data taken by a camera module of a portable terminal. Such a method photographs books or name cards through a camera module included in the portable terminal and extracts and recognizes characters through full scan of photographed data. The recognized characters are again converted into an input possible text form by a portable terminal to be provided through a display unit. Accordingly, a user selects a specific object from a text displayed on the display unit to determine a dictionary meaning with respect to a corresponding object. That is, a dictionary function provided associated with a camera module in a portable terminal of the related art scans total photographing data taken by the camera module to recognize a text. In this case, it takes a long time to perform processing according to full scan for photographing data. As a result, it takes a long time for a user to use a dictionary function.

Therefore, a need exists for a method capable of providing a dictionary function using preview data through a camera module and a portable terminal supporting the same.

### SUMMARY OF THE INVENTION

Aspects of the present invention are to address at least the above-mentioned problems and/or disadvantages and to provide at least the advantages described below. Accordingly, an aspect of the present invention is to provide a method capable of providing a dictionary function using preview data through a camera module and a portable terminal supporting the same.

Another aspect of the present invention is to provide a method for providing a dictionary function and result information thereof using real time preview data and augmented reality in a portable terminal having a camera module and a portable terminal supporting the same.

Another aspect of the present invention is to provide a method for detecting a specific object on preview data according to touch based interaction and displaying dictionary result information about the detected object as augmented reality on the preview data, and a portable terminal supporting the same.

In accordance with an aspect of the present invention, a method for providing a dictionary function in a portable terminal is provided. The method includes displaying preview data of specific contents, receiving touch based interaction on the preview data, detecting an object corresponding to the interaction, searching for additional information about the object, and generating the found additional information as result information and outputting the generated additional information on the preview data using augmented reality.

The detecting of an object may include detecting the object by scan of an edge detection scheme based on a coordinate to which interaction is input on the preview data. Moreover, the detecting of the object may include determining whether a specific object is detected in a first scan range, enlarging a radius of the first scan range by a predefined value when the specific object is not detected, and determining whether a specific object is detected in a second enlarged scan range.

In accordance with another aspect of the present invention, there is provided a computer-readable recording medium on which a program for executing the method in a processor is recorded.

In accordance with another aspect of the present invention, a portable terminal is provided. The terminal includes a camera module for transferring preview data of specific contents to a display unit, the display unit for displaying the preview data, and for displaying result information of an object corresponding to touch based interaction using augmented reality, a memory for storing additional information for a dictionary function with respect to various objects, and a controller for detecting a specific object on the preview data according to touch based interaction and for controlling output of result information about the detected object on the preview data using augmented reality.

As illustrated above, a method and an apparatus for providing a dictionary function in a portable terminal may search for additional information about a specific object by only a simple interaction input on real time preview data. Furthermore, additional information may be provided using augmented reality to improve the intuition of a user. That is, a user may select a specific object as touch based interaction input and provide additional information about the selected object using augmented reality in a real-time manner.

In an exemplary embodiment of the present invention, a user may search for additional information about various real contents regardless of time and space. That is, the user may use a dictionary function using augmented reality by a simple touch operation on preview data of specific contents corresponding to a real world. Furthermore, in an exemplary embodiment of the present invention, user interaction may scan character recognition based on an input part to shorten image processing time, thereby supporting rapid search. Exemplary embodiments of the present invention may increase a character recognition rate using real time auto focus. Apart from real contents of near distance like books, it may support object recognition with respect to real contents at a long distance using auto focus. Accordingly, when a user moves for sightseeing, the user may easily extract an object with respect to real contents, such as a signboard, a mark plate, or a guide of an airport and search for additional information thereof

An exemplary embodiment of the present invention may be implemented in a camera module and various types of devices supporting a dictionary function. An exemplary embodiment of the present invention may implement an optimal environment for searching for additional information of real world contents provided with preview data to improve usability, convenience, accessibility, and competitive force of a portable terminal

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a portable terminal according to an exemplary embodiment of the present invention;

FIG. 2 illustrates an operation providing result information about an object designated by a touch based user interaction on preview data according to an exemplary embodiment of the present invention;

FIG. 3 illustrates an operation recognizing an object corresponding to user interaction by edge detection based scan to provide result information thereof according to an exemplary embodiment of the present invention;

FIG. 4 illustrates an operation of a dictionary function using result information based on interaction according to exemplary embodiments of the present invention; and

FIG. 5 is a flowchart illustrating a method for providing a dictionary function in a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention relate to a method and an apparatus for providing a dictionary function in a portable terminal having a camera module. An exemplary embodiment of the present invention may input touch based interaction on preview data through a camera module to easily execute a dictionary function. An exemplary embodiment of the present invention may intuitively provide result information about an object of an input location of interaction in preview data using augmented reality. In an exemplary embodiment of the present invention, the augmented reality is adapted to overlap a three-dimensional virtual object on a real world while showing the three-dimensional virtual object. The augmented reality indicates a technology for increasing understanding for a real world by combining a virtual reality of a graphic form with a real world based on reality. Accordingly, in an exemplary embodiment of the present invention, the result information is overlapped with preview data being a real environment which a user views when it is displayed in a real time manner.

The object indicates a target from which result information is to be extracted through a dictionary function by a user. The object includes all elements constituting preview data input through a camera module, and may indicate a text or an icon (e.g., a trademark) as a representative example. Exemplary embodiments of the present invention may extract an object of a generated location of touch based interaction when the interaction is input on preview data input through a camera module and obtain result information through recognition of the extracted object. Accordingly, the object recognition may be achieved by algorithm driving for text recognition or icon recognition according to an extracted object, which may be associated with various algorithms for object recognition.

Hereinafter, a configuration of a portable terminal and an operation control method thereof according to an exemplary embodiment of the present invention will be described with the accompany drawings. However, because a configuration of a portable terminal and an operation control method thereof according to an exemplary embodiment of the present invention are not limited to the following embodiments, it should be noticed that various embodiments are applicable based on the following exemplary embodiments.

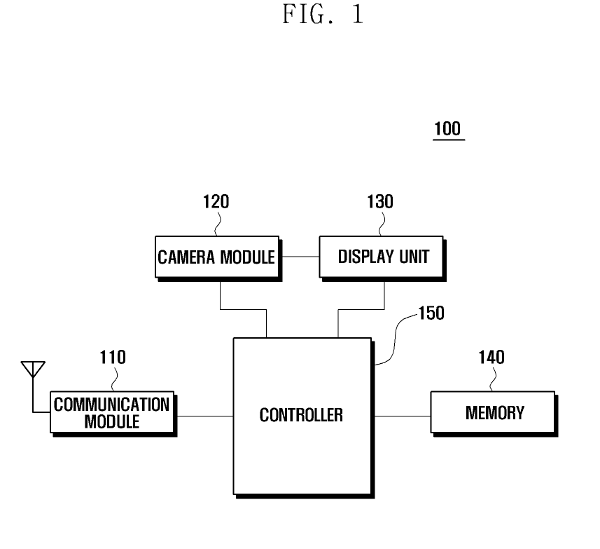

FIGS. 1 through 5, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating a configuration of a portable terminal according to an exemplary embodiment of the present invention.

Referring to FIG. 1, a portable terminal 100 includes a communication module 110, a camera module 120, a display unit 130, a memory 140, and a controller 150.

In addition, the portable terminal 100 may include an audio processor having a microphone and a speaker, a digital broadcasting module for receiving and playing digital broadcasting (e.g., mobile broadcasting, such as Digital Multimedia Broadcasting (DMB) or Digital Video Broadcasting (DVB)), a camera module for photograph/moving image photographing functions, a Bluetooth communication module for executing a Bluetooth communication function, an Internet communication module for executing an Internet communication function, a touch pad for touch based input, an input unit for supporting physical key input, and a battery for supplying power to the foregoing elements, and thus a description and drawings thereof are not omitted.

The communication module 110 supports services, such as mobile communication based mobile communication service and Wireless Local Area Network (WLAN) based Internet service (e.g., a Wireless-Fidelity (Wi-Fi) service). The communication module 110 may form a communication channel with a predefined network and process data transmission and reception through the formed communication channel. More particularly, the communication module 110 may access an information providing server through a mobile communication service and an Internet service to process data transmission and reception.

The camera module 120 photographs an optional subject and transfers image data to the display unit 130 and the controller 150. In an exemplary embodiment of the present invention, the camera module 120 may be driven under the control of the controller 150 upon execution of a dictionary application. When the camera module 120 is driven according to execution of the dictionary application, it may transfer preview data of a subject (e.g., specific contents of a real world) input through a sensor to the display unit 130.

The display unit 130 provides respective execution screens of applications supported from the portable terminal 100 as well as a home screen of the portable terminal 100. For example, the display unit 130 provides execution screens of a message function, an electronic mail function, an Internet function, a searching function, a communication function, an electronic book (e.g., an e-book) function, photograph/moving image taking functions, photograph/moving image playing functions, a mobile broadcasting playing function, a music playing function, a game function, and the like. A Liquid Crystal Display (LCD) is used as the display unit 130. Other display devices, such as a Light Emitting Diode (LED), an Organic LED (OLED), an Active Matrix OLED (AMOLED), and the like, may also be used. When displaying the foregoing execution screen (more particularly, preview data or image data transferred to the camera module 120), the display unit 130 may provide a horizontal mode or a vertical mode according to a rotating direction (or put direction) of the mobile device.

Furthermore, the display unit 130 may display preview data transferred to the camera module 120, and receive and transfer user interaction in a displayed state of the preview data to the controller 150. Accordingly, the display unit 130 may include an interface supporting touch based input. For example, the display unit 130 may support touch based user interaction input by a configuration of a touch screen, and generate and transfer an input signal according to the user interaction input to the controller 150. Although one display unit 130 is provided, at least two display units may be included in the portable terminal 100 in an exemplary embodiment of the present invention.

The memory 140 stores various programs and data executed and processed by the portable terminal 100, and may be configured by at least one non-volatile memory and volatile memory. The non-volatile memory may be a Read Only Memory (ROM) or a flash memory and the volatile memory may be a Random Access Memory (RAM). The memory 140 may continuously or temporarily store an operating system of the mobile device, programs and data associated with a display control operation of the display unit 100, programs and data associated with an input control operation using the display unit 130, programs and data associated with a function control operation of the camera module 120, and programs and data associated with a dictionary function control operation of the portable terminal 100. More particularly, in an exemplary embodiment of the present invention, the memory 140 may construct and store additional information about various types of object based on a database (DB). That is, the memory 140 may store additional information for supporting a dictionary function of objects corresponding to various contents of a real world.

The controller 150 controls an overall operation of the portable terminal 100. More particularly, the controller 150 may control an operation associated with a dictionary function operation of the present invention. For example, upon execution of a dictionary application, the controller 150 may control driving of the camera module 120. Furthermore, the controller 150 may detect an object according to interaction input on preview data by the camera module 120 in a state that the preview data is displayed on the display unit 130. Moreover, the controller 150 may analyze the detected object to generate result information about corresponding object. At this time, the controller 150 determines whether information about the object is included in the memory 140. When the information about the object is included in the memory 140, the controller 150 may construct and display result information regarding the object based on the information stored in the memory 140. In contrast, when the information about the object is not included in the memory 140, the controller 150 may drive the communication module 110 to request information about the object to an external server (e.g., an information providing server), and construct and display result information about the object based on information received from the external server. Upon providing the result information, the controller 150 may display it on the preview data based on an input location of interaction using augmented reality. More particularly, the controller 150 may display the result information in the vicinity of an input location of the interaction, namely, a location of the object in a pop-up form, and may visualize and display the object in a form of a shadow effect as augmented reality. The control operation of the controller 150 will be described in a description of an example of an operation of the portable terminal 100 and a control method thereof

Moreover, the controller 150 may control various operations associated with a general function of the portable terminal 100. For example, upon execution of an application, the controller 150 may control an operation and data display of the application. Furthermore, the controller 150 may receive an input signal corresponding to various input schemes supported from a touch based interface to control a function operation according thereto. The controller 150 may control transmission and reception of various data based on wired or wireless communication.

The portable terminal 100 of the present invention shown in FIG. 1 is applicable to various types of device, such as a bar type, a folder type, a slide type, a swing type, and a flip type. Furthermore, a portable terminal of the present invention has a camera module, and may include various information communication devices, multi-media devices, and application devices thereof supporting a dictionary function of the present invention. For example, the portable terminal includes a tablet Personal Computer (PC), a Smart Phone, a Portable Multimedia Player (PMP), a digital broadcasting player, a Personal Digital Assistant (PDA), and a portable game terminal as well as a mobile communication terminal operated based on respective communication protocols corresponding to various communication systems.

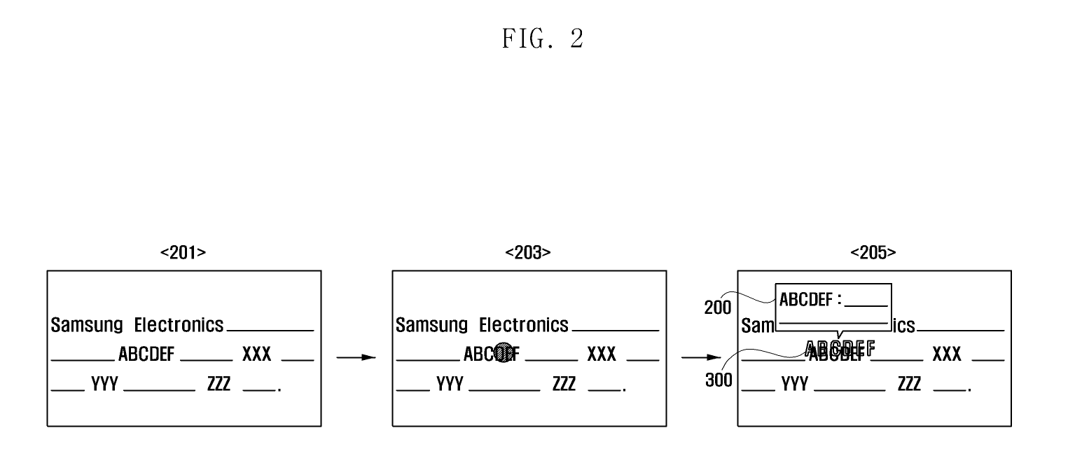

FIG. 2 illustrates an operation providing result information about an object designated by a touch based user interaction on preview data according to an exemplary embodiment of the present invention.

Referring to FIG. 2, a user may execute a dictionary application for searching for additional information with respect to specific contents (e.g., a dictionary, a signboard, a mark plate, a guide) of a real world. Accordingly, the controller 150 may control driving of the camera module 120. Furthermore, if the camera module 120 is driven, as illustrated in reference numeral 201, preview data input for preview may be displayed on the display unit 130 as illustrated in reference numeral 201. In this case, the preview data indicates an image for the specific contents of a real world input by the camera module 120 as preview.

Thereafter, in a displayed state of preview as illustrated in reference numeral 201, a user may input interaction for searching for additional information of a specific object. For example, the user may input touch based interaction at a region of an “ABCDEF” text as illustrated in reference numeral 203.

Subsequently, the controller 150 may discriminate an object corresponding to the interaction and search for additional information about corresponding object to generate result information. Furthermore, the generated result information may be displayed using augmented reality. For example, as illustrated in reference numeral 205, result information 200 may be displayed in the vicinity of a text of “ABCDEF” to which the interaction is input. In this case, the result information 200 may be displayed through augmented reality by simply constructing information (e.g., a dictionary meaning or additional information) found with respect to a recognized object (e.g., “ABCDEF”). Furthermore, the result information 200 may include a shadow object 300. In an exemplary embodiment of the present invention, the shadow object 300 indicates an object displayed by augment reality of a form having the same element (e.g., a text spelling, an icon form) as that of a specific object recognized according to interaction to overlap the specific object. For example, the shadow object 300 has the same text spelling as that of “ABCDEF” being the recognized object and is displayed in a three-dimensional way to be adjacent to “ABCDEF”, preview data of a real world. Furthermore, the shadow object 300 may be displayed as an opaque object (opaque text or icon according to a type of real object) to be distinguished from the real object.

Upon detecting the interaction input requesting additional information about a specific object, the controller 150 may recognize a coordinate to which interaction is input and analyze an object while scanning a periphery of a corresponding coordinate. At this time, the controller 150 may detect (or recognize) an object by scanning, using an edge detection scheme. The edge detection is a type of image processing, and may be an operation or algorithm extracting a boundary of an object. The edge detection is used to detect a peripheral object to which interaction is input. A scan scheme according to edge detection of the present invention will be described below.

Meanwhile, object recognition according to the scan may not be achieved normally. For example, noise may be included in an image as the preview data are displayed dark. In this case, the controller 150 may further perform processing for improving image quality. In an exemplary embodiment of the present invention, object recognition by Auto Focus (AF) may be performed to clarify object recognition. In this case, an auto focus function may be executed based on a coordinate to which interaction is input to focus a periphery of the coordinate to increase accuracy of object recognition.

Subsequently, if object recognition is normally performed by the foregoing operation, the controller 150 may search for information about a recognized object to generate result information based on the found information. In this case, the information search may be achieved by the memory 140 or an external server.

Thereafter, the controller 150 may display result information generated as previously illustrated using augmented reality. For example, the controller 150 may combine preview data of a real world with result information of a Graphical User Interface (GUI) form and display the combined result in a three-dimensional way. Such an example is illustrated in reference numeral 205.

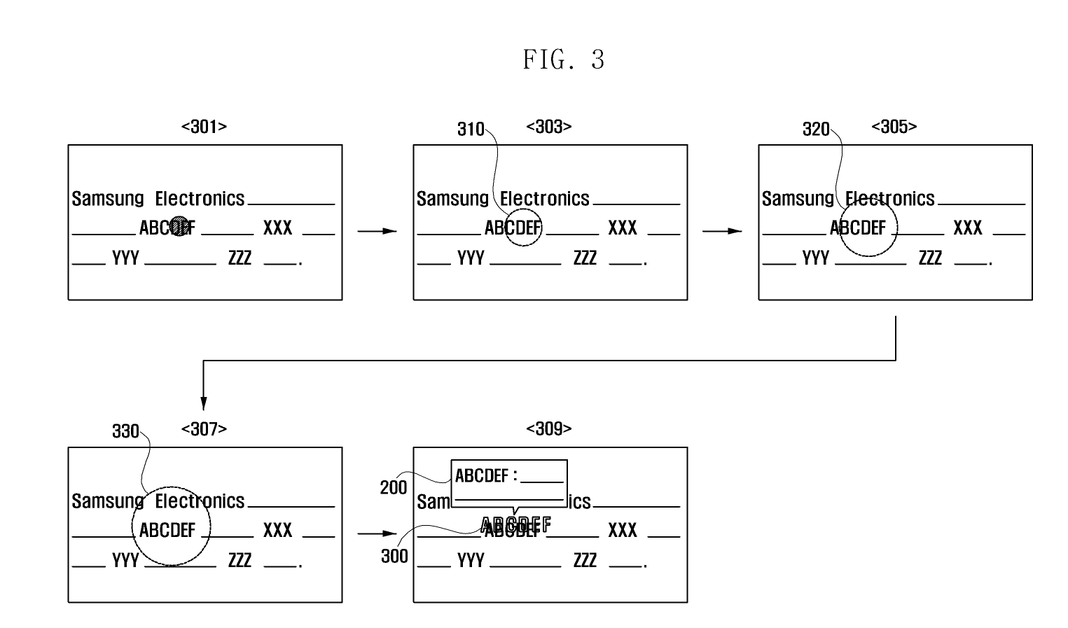

FIG. 3 illustrates an operation recognizing an object corresponding to user interaction by edge detection based scan to provide result information thereof according to an exemplary embodiment of the present invention.

Referring to FIG. 3, it is assumed that preview data with respect to specific contents of a real world are displayed on a display unit 130 as previously illustrated. In a state of reference numeral 301, a user may input touch based interaction for searching for additional information of a specific object.

Accordingly, as illustrated in reference numeral 303, reference numeral 305, and reference numeral 307, the controller 150 may scan according to edge detection until an intact object is detected. For example, as illustrated in reference numeral 303, the controller 150 scans an object within a scan range 310 of a preset minimal radius based on a coordinate to which the interaction is input. If the scanned object is not the intact object, the controller 150 increases a scan range 310 of a preset minimal radius by a preset value. For example, as illustrated in reference numeral 305, the scan range 310 of a preset minimal radius may be increased to enlarge a scan range 320 by a first increased radius. Through the operation, as illustrated in reference numeral 307, a scan range 330 may be enlarged by an n-th increased radius (n>1). As illustrated in reference numeral 307, it will be appreciated that an intact object (e.g., a text of “ABCDEF”) is displayed to be included in a scan range 330. In an exemplary embodiment of the present invention, recognition of the intact object may be achieved by applying an object recognition algorithm with respect to an object in a scan range.

Here, at least two intact objects may be detected according to the scan. In this case, the controller 150 may display a visual effect (e.g., a highlight processing) of at least two detected intact objects on preview data and request user selection from at least two intact objects. Accordingly, a user may again input interaction selecting a specific object from at least two intact objects, and the controller 150 may detect any one specific object corresponding to the foregoing procedure according to the interaction. In this case, after detection of at least two intact objects, the controller 150 may apply auto focus to increase the clarity of object detection.

Thereafter, as illustrated in reference numeral 307, when an intact object is scanned and recognized, additional information about a corresponding object (e.g., a text of “ABCDEF”) may be searched to display and generate corresponding result information. For example, as illustrated in reference numeral 309, result information 200 may be displayed using augmented reality. As previously illustrated, the result information may be displayed on the preview data to include a shadow object 300 for the object.

Meanwhile, although the result information 200 and 300 are not shown and omitted in FIG. 2 and FIG. 3, they may be removed from preview data according to user selection in a displayed state thereof as previously illustrated. When the preview data also change due to movement of a portable terminal in the displayed state of the result information 200 and 300, the result information 200 and 300 may be removed from the preview data. As previously illustrated, when the preview data changes, the result information 200 and 300 may be removed by applying a visual effect where the result information gradually disappears on the preview data. At this time, when the preview data is again restored to a previous state of change, the result information 200 and 300 may be selectively maintained or removed. This may be performed by buffering a coordinate according to interaction, an object corresponding to the coordinate, result information for a predefined time and comparing and analyzing a buffered coordinate, an object corresponding to the coordinate, and result information upon detecting an event the preview of which is changed.

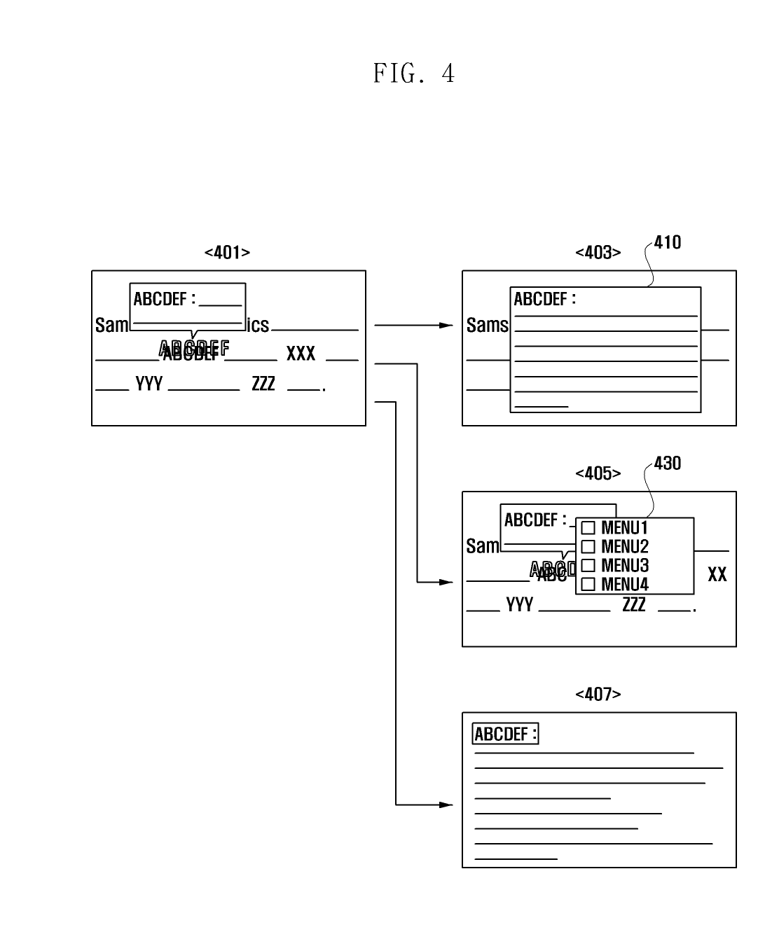

FIG. 4 illustrates an operation of a dictionary function using result information based on interaction according to an exemplary embodiment of the present invention.

Referring to FIG. 4, as illustrated in reference numeral 401, it is assumed that result information about a specific object (e.g., a text of “ABCDEF”) is displayed on preview data about specific contents of a real world using augmented reality. Furthermore, detailed information about a specific object may be provided in various schemes as illustrated in reference numeral 403, reference numeral 405, and reference numeral 407 according to user interaction input on result information in a state of reference numeral 401.

For example, a user may input a first interaction (e.g., continuous two tap interactions) on result information in a state of reference numeral 401. Accordingly, as illustrated in reference numeral 403, the result information may disappear and a pop-up window 410 having detailed information about the object may be displayed.

Furthermore, in a state of reference numeral 401, a second interaction (e.g., a one tap interaction) may be input on result information. Accordingly, as illustrated in reference numeral 405, a pop-up window 430 having a menu for selecting a predefined function may be displayed in a maintained state of the result information. At this time, in reference numeral 405, the result information may be removed but only a pop-up window 430 having a menu may be provided. Furthermore, the user may select a predefined menu item from menus provided on the pop-up window 430 to execute a specific function. For example, menus, such as a web search, additional information correction and transmission, and an environment setting may be provided, and a user may selectively execute a function mapped to a specific menu.

The web search may be a function supporting search for additional information about the object through the web. The additional information correction may be a function supporting correction of additional information displayed as result information. The additional information transmission may be a function supporting transmission of additional information about the object to another portable terminal. The environment setting may be a function to support setting a result information expression scheme and presence of application of augmented reality.

Moreover, a user may input a third interaction (e.g., a long press interaction) on result information in a state of reference numeral 407. Accordingly, as illustrated in reference numeral 407, a screen is converted to a web screen and a search screen based on the web for the object may be displayed. For example, upon detecting the third interaction input on the result information, the controller 150 may drive the communication module 110 to control accessing of an external server previously defined based on mobile communication or the Internet. In addition, the controller 150 may request search for additional information about the object to the external server and display a result screen according thereto.

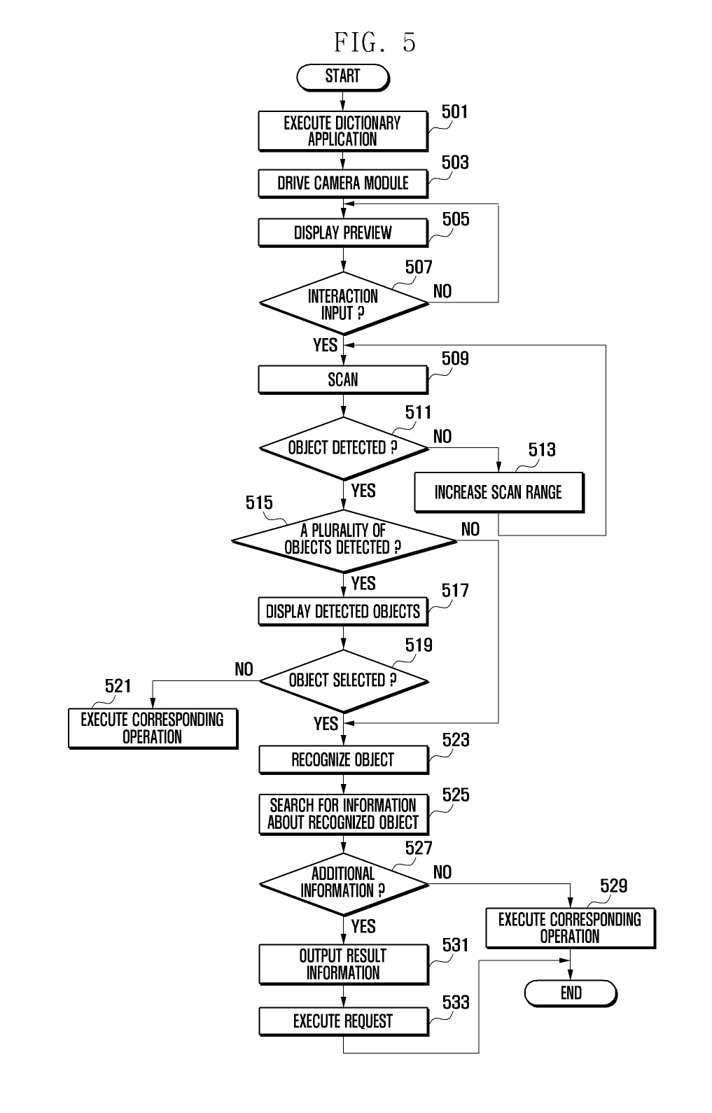

FIG. 5 illustrates an operation of a dictionary function in a portable terminal according to an exemplary embodiment of the present invention.

Referring to FIG. 5, a controller 150 may control execution of a dictionary application according to a user request at step 501. Thereafter, the controller 150 may control driving of a camera module upon execution of the dictionary application at step 503, and display a preview with respect to specific contents (e.g., a book, a signboard, a mark plate, a guide, etc.) of a real world at step 505. Upon execution of the dictionary application, the camera module 120 is driven, and preview data about the specific contents of a real world input through the camera module 120 are displayed on a display unit 130 in a preview format.

Subsequently, the controller 150 may determine whether touch based interaction is input in a displayed state of the preview data at step 507. If the interaction is not input (NO of step 507), the controller 150 may return to step 505 and control execution of following operations.

In contrast, when the interaction is input (YES of step 507), the controller 150 may scan based on a coordinated to which the interaction is input at step 509. For example, a user may input touch based interaction for searching for additional information on the preview data. Accordingly, the display unit 130 may transfer an input signal according to the interaction to the controller 150, and the controller 150 may recognize a coordinate to which the interaction is input according to reception of the input signal according to the interaction. Furthermore, the controller 150 may scan using edge detection based on a coordinate to which the interaction is input to perform object recognition.

Thereafter, the controller 150 may determine whether a predefined object is detected at step 511. If the predefined object is not detected (NO of step 511), the controller 150 may increase a scan range by a predefined radius at step 513, and return to step 509 to control following operations. If the predefined object is not detected due to noise, the controller 150 may operate an auto focus function as illustrated above.

In contrast, if the predefined object is detected (YES of step 511), the controller 150 may determine whether a plurality of objects are detected at step 515. When it is determined that a single object is detected (NO of step 515), the controller 150 goes to step 523. In contrast, when it is determined that the plurality of objects are detected (YES of step 515), the controller 150 may control visual display of the detected objects (e.g., a highlight processing) at step 517.

Thereafter, the controller 150 may determine whether an object is selected from the plurality of objects at step 519. If the one object is not selected (NO of step 519), the controller 150 may control execution of a corresponding operation at step 521. For example, the controller 150 may advance to an initial step corresponding to a user request to control execution of operation displaying and scanning new preview data. If there is no user selection for a predefined time, the controller 150 may initialize the foregoing operations. When change of preview data is detected while waiting for user selection with respect to a plurality of objects, the controller 150 may remove visual display and display of changed preview data.

In contrast, if the object is selected (YES of step 519), the controller 150 may recognize a corresponding object at step 523. At this time, when object recognition according to scan is not achieved normally, the controller 150 may further perform image quality improvement or object recognition by auto focus.

Subsequently, the controller 150 may search for information about the recognized object at step 525. Thereafter, the controller 150 may determine whether there is additional information about the object at step 527. For example, the controller 150 may search and extract the additional information about the object from a memory 140 and determine whether the additional information about the object is included in the memory 140.

When there is no additional information about the object (NO of step 527), the controller 150 may control execution of a corresponding operation at step 529. For example, the controller 150 may control the communication module to access an external server previously defined based on mobile communication or the Internet, and search for additional information about the object from a corresponding external server to extract result information thereof.

In contrast, when there is the additional information corresponding to the object (YES of step 527), the controller 150 may control output of result information configured based on the additional information at step 531. At this time, as previously illustrated, upon output of the result information, the controller 150 may generate a shadow object with respect to the object, and display a combination of the shadow object and additional information using augmented reality.

Subsequently, the controller 150 may control execution of a request operation after output of the result information at step 533. For example, as illustrated in a description of FIG. 4, the controller 150 may control output of detailed information about the object, menu output, and output of relation information based on the web according to user interaction input on the result information.

The foregoing method for providing a dictionary function of the present invention may be implemented in an executable program command form by various computer means and be recorded in a computer readable recording medium. In this case, the computer readable recording medium may include a program command, a data file, and a data structure individually or a combination thereof. Moreover, the program command recorded in the recording medium may be specially designed or configured for the present invention or be known to a person having ordinary skill in a computer software field to be used.

The computer readable recording medium includes a Magnetic Media, such as a hard disk, a floppy disk, or a magnetic tape, an Optical Media, such as a Compact Disc Read Only Memory (CD-ROM) or a Digital Versatile Disc (DVD), a Magneto-Optical Media, such as a floptical disk, and a hardware device, such as a ROM, a RAM, and a flash memory for storing and executing program commands. Furthermore, the program command includes a machine language code created by a complier and a high-level language code executable by a computer using an interpreter. The foregoing hardware device may be configured to be operated as at least one software module to perform an operation of the present invention, and a reverse operation thereof is the same.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for providing a dictionary function in a portable terminal, the method comprising:
displaying preview data of specific contents;
receiving touch based interaction on the preview data;
detecting an object corresponding to the interaction;
searching for additional information about the object; and
generating found additional information as result information and outputting the generated additional information on the preview data based on augmented reality.

2. The method of claim 1, wherein the displaying of the preview data of the specific contents comprises:
executing a dictionary application corresponding to a user request;
driving a camera module upon execution of the dictionary application; and
displaying the preview data input for preview from the camera module as preview.

3. The method of claim 2, wherein the detecting of the object comprises detecting the object by scan of an edge detection scheme based on a coordinate to which interaction is input on the preview data.

4. The method of claim 3, wherein the detecting of the object comprises:
determining whether a specific object is detected in a first scan range;
enlarging a radius of the first scan range by a preset value when the specific object is not detected; and
determining whether a specific object is detected in a second enlarged scan range.

5. The method of claim 3, wherein the displaying of the preview data input for preview comprises combining the preview data based on augmented reality with result information of a Graphical User Interface (GUI) form and displaying the combined result in three-dimensions.

6. The method of claim 3, wherein the detecting of the object comprises:
visually displaying a plurality of detected objects when the plurality of objects are detected based on a coordinate to which the interaction is input; and
detecting the object according to user selection among the plurality of objects.

7. The method of claim 2, wherein the searching for the additional information comprises:
searching for the additional information about the object from a memory; and
searching for the additional information about the object from an external server when the additional information is not included in the memory.

8. The method of claim 2, wherein the outputting of the generated additional information comprises outputting the additional information and a shadow object with respect to the object based on the augmented reality.

9. The method of claim 8, further comprising outputting any one of detailed information about the object, a menu, or relation information based on a web according to user interaction input on the result information.

10. A portable terminal comprising:
a camera module for transferring preview data of specific contents to a display unit;
the display unit for displaying the preview data, and for displaying result information of an object corresponding to touch based interaction based on augmented reality;
a memory for storing additional information for a dictionary function with respect to various objects; and
a controller for detecting a specific object on the preview data according to touch based interaction and for controlling output of result information about the detected object on the preview data based on augmented reality.

11. The terminal of claim 10, wherein the result information comprises additional information about the object and a shadow object with respect to the object.

12. The terminal of claim 11, wherein the controller detects the object by scan of an edge detection scheme based on a coordinate to which interaction is input on the preview data.

13. The terminal of claim 11, wherein the controller determines whether a specific object is detected in a first scan range, enlarges a radius of the first scan range by a preset value when the specific object is not detected, and determines whether a specific object is detected in a second enlarged scan range.

14. The terminal of claim 11, wherein the controller combines preview data based on augmented reality with result information of a Graphical User Interface (GUI) form and displays the combined result in three-dimensions.

15. The terminal of claim 13, wherein the controller controls detection of the object according to user selection among the plurality of objects when the plurality of objects are detected based on a coordinate to which the interaction is input.

16. The terminal of claim 11, wherein the controller controls output of any one of detailed information about the object, a menu, or relation information based on a web according to user interaction input on the result information.

17. The terminal of claim 10, further comprising a communication module for communicating with an external server to process data transmission and reception.
